(19) United States
(12) Patent Application Publication
(10) Pub. No.: US 2018/0167098 A1
(43) Pub. Date: Jun. 14, 2018

(54) DETECTING PRESENCE OF PROTECTIVE CASE

(71) Applicant: Otter Products, LLC, Fort Collins, CO (US)

(72) Inventor: Peter S. Armstrong, Poway, CA (US)

(21) Appl. No.: 15/837,500

(22) Filed: Dec. 11, 2017

Related U.S. Application Data
(60) Provisional application No. 62/433,905, filed on Dec. 14, 2016.

(51) Int. Cl. H04B 1/3888; H04M 1/02; G01H 1/00

(52) U.S. Cl. CPC H04B 1/3888; H04M 2250/12; G01H 1/00; H04M 1/0202

(57) ABSTRACT

A system for detecting presence of a protective case on an electronic device includes a removable protective case for an electronic device and a set of computer instructions storable on a non-transitory storage medium. The set of computer instructions is executable by one or more computer processors of the electronic device to generate a vibration in the electronic device through activation of a haptic motor of the electronic device. The instructions are further configured to receive data measured by an accelerometer of the electronic device, where the data is measured during the generation of the vibration, and compare the received data to a known vibration signature of the electronic device to determine if the protective case is attached to the electronic device.

### CROSS REFERENCE TO RELATED APPLICATIONS

This application claims the benefit of U.S. Provisional Application No. 62/433,905, filed Dec. 14, 2016, the entirety of which is hereby incorporated by reference.

### FIELD

The present disclosure relates to cases, covers, and/or encasements for electronic devices. More specifically, the present application relates to apparatuses, systems, and methods for detecting if a protective case, cover, or encasement is on an electronic device.

### BACKGROUND

Portable electronic devices are commonly used for communication and entertainment purposes. Portable electronic devices include devices such as smartphones, cellular phones, mobile communication devices, computers, portable computing devices, mobile computing devices, tablet computers, cameras, video players, smart watches, audio players, electronic media readers, two-way radios, global positioning satellite (GPS) devices, measurement instruments, and/or other types of electronic, computing, or communication devices, including combinations thereof. Cases, protective cases, covers, protective covers, enclosures, or encasements are sometimes installed on or over housings of these types of electronic devices in order to protect the electronic devices from damage due to exposure to shock, impact, dropping, puncture, dust, dirt, water, snow, rain, mud, chemicals, and/or other potentially damaging forces or elements. The term “case” is used herein to refer to any type of case, cover, protective case, protective cover, enclosure, encasement, shell, or combination thereof. Cases are also sometimes used to supplement the functionality of the device and/or to change the aesthetics of the device.

It may be desirable to automatically, remotely, and/or electronically detect if a case is installed on an electronic device. Among other purposes, detecting whether a case is installed on the electronic device may provide useful information for purposes of evaluating a warranty or damage claim that the protective case did not properly protect the electronic device. In other words, if a user claims that an electronic device incurred some damage even though the case was installed on the device, it may be useful to have captured data verifying that the case was in fact installed on the device.

There may also be other benefits or purposes for automatically, remotely, and/or electronically detecting if a case is present on the electronic device. In one example, the manufacturer of the electronic device may provide a different warranty, such as a longer warranty, if the electronic device is kept in the case. In another example, a manufacturer of the case may provide some level of insurance on the electronic device as long as the case is installed on the device. In yet another example, an electronic device may only be permitted to be used in certain environments if the case is installed on the device. For example, measurements which are to be made in an industrial environment may only be enabled when the device has detected that the protective case is present in order to protect the device from damaging forces or substances in the industrial environment.

Improved systems, apparatuses, and methods which solve these and other problems are disclosed herein.

### SUMMARY

In one example, a system for detecting presence of a protective case on an electronic device includes a removable protective case for an electronic device and a set of computer instructions storable on a non-transitory storage medium. The set of computer instructions is executable by a computer processor of the electronic device to generate a vibration in the electronic device through activation of a haptic motor of the electronic device. The instructions are further configured to receive data measured by an accelerometer of the electronic device, where the data is measured during the generation of the vibration, and compare the received data to a known vibration signature of the electronic device to determine if the protective case is attached to the electronic device.

Various other embodiments and variations of the techniques and methods are also disclosed. While multiple embodiments are disclosed, still other embodiments will become apparent to those skilled in the art from the following detailed description and figures, which describe and show illustrative embodiments of the invention. As will be realized, the invention is capable of modifications in various aspects, all without departing from the scope of the present invention. Accordingly, the drawings and detailed description are to be regarded as illustrative in nature and not restrictive.

### BRIEF DESCRIPTION OF THE DRAWINGS

The present invention will be described and explained through the use of the accompanying drawings in which:

FIG. 1 illustrates a front perspective view of a protective case and an electronic device;

FIG. 2 illustrates a system for detecting presence of a protective case;

FIGS. 3A-3C illustrate vibration response measurement data taken from an electronic device with no protective case installed;

FIGS. 4A-4C illustrate vibration response measurement data taken from the electronic device with a protective case installed;

FIGS. 5A-5D illustrate vibration response measurement data taken from an electronic device with no protective case installed while the electronic device is sitting on a table; and

FIG. 6 illustrates a method of detecting presence of a protective case on an electronic device.

### DETAILED DESCRIPTION

In the following detailed description, various specific details are set forth in order to provide an understanding of and describe the apparatuses and techniques introduced here. However, the techniques may be practiced without the specific details set forth in these examples. Various alternatives, modifications, and/or equivalents will be apparent to those skilled in the art without varying from the spirit of the introduced apparatuses and techniques. For example, while the embodiments described herein refer to particular features, the scope of this solution also includes embodiments having different combinations of features and embodiments that do not include all of the described features. Accordingly, the scope of the techniques and solutions introduced herein are intended to embrace all such alternatives, modifications, and variations as fall within the scope of the claims, together with all equivalents thereof. Therefore, the description should not be taken as limiting the scope of the invention, which is defined by the claims.

Some of the cases described herein are described as protective cases. However, the apparatuses and techniques disclosed herein are not to be limited to any particular protective characteristic of the case and may be applicable to various types of cases, covers, and/or encasements which cover an electronic device either partially or fully.

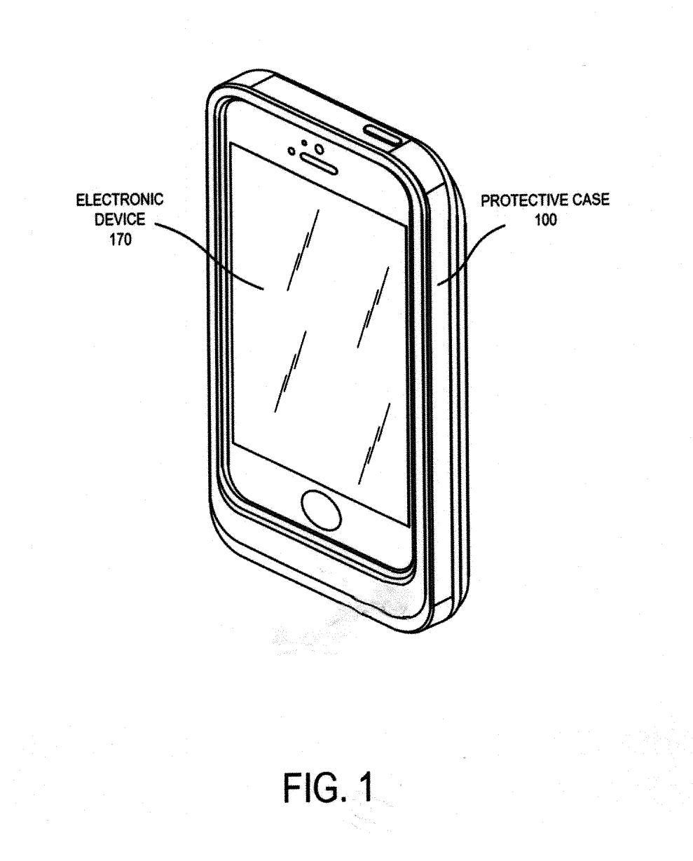

FIG. 1 illustrates a front perspective view of protective case 100 for electronic device 170 in accordance with the apparatuses, systems, methods, and techniques introduced herein.

Electronic device 170 may be a cellular phone, smartphone, mobile communication device, mobile computing device, portable computing device, tablet, phablet (phone/tablet), portable computer, personal video player, electronic media reader, audio player, handheld scanner, camera, GPS device, or electronic computing or communication device of another type, including combinations thereof. In one specific example, electronic device 170 may be an APPLE IPHONE. In another specific example, electronic device 170 may be a SAMSUNG GALAXY phone.

Protective case 100 comprises any type of protective shell, cover, covering, enclosure, bumper, sheath, encasement, member, and/or a combination thereof used with the electronic device 170. Protective case 100 may provide protection against forces or damaging elements such as shock, impact, dropping, puncture, dust, dirt, heat, cold, water, snow, rain, mud, fluids chemicals, and/or other potentially damaging elements. In various instances, as described in further detail below, protective case 100 may be waterproof, watertight, and/or water-resistant. In other examples, techniques disclosed herein may implemented in the form of a cover for electronic device 170 which provides some or all of the functions disclosed herein while having little or no protective characteristics.

Protective case 100 may encase or cover electronic device 170, partially or fully. For example, in various configurations, protective case 100 may attach, contact, or interface to only a single surface of electronic device 170 or may attach, contact, or interface with a plurality of surfaces of electronic device 170. In some configurations, protective case 100 may include a membrane positioned over an interactive control panel or a touch screen interface of electronic device 170 such that inputs provided by a user on an outside surface of the membrane can be detected by electronic device 170 through the membrane. In some configurations, a membrane may not be present. However, even in instances where a membrane is not present, protective case 100 may still be waterproof or water-resistant when electronic device 170 is installed. This may be accomplished using one or more gaskets, seals, or o-rings that seal between protective case 100 and a surface of electronic device 170, such as a perimeter of the touchscreen or the housing of electronic device 170. Such sealing may enable a remaining portion of electronic device 170 to be protected in a waterproof or water-resistant manner even though a portion of electronic device 170 is directly accessible and/or exposed.

Protective case 100 may include one member, two member, or more than two members. Some of these members may be permanently attached to each other and some of these members may be removably attachable to each other for insertion and/or removal of electronic device 170 from protective case 100. In some situations, protective case 100 may be a one-piece case or a one-piece assembly into which electronic device 170 snaps or slides. Protective case 100 may also include one or more cushion members, cushion layers, and/or cushion portions that are removably attached or permanently attached to any combination of the one, two, or more members. Any portion of protective case 100 may be made of any suitable material, including, but not limited to, polycarbonate (PC), high impact polystyrene (HIPS), nylon, fiberglass-filled nylon, acrylonitrile butadiene styrene (ABS), polyoxymethylene (POM), polyethylene terephthalate (PET), ceramic, metallized ceramic, aluminum, aluminum alloy, titanium, wood, carbon fiber, and/or any combination thereof. The techniques disclosed herein are not to be limited to any particular type, structure, or configuration of case.

It may be desirable to automatically, remotely, and/or electronically detect if protective case 100 is installed on electronic device 170 at any particular point in time. Detecting whether protective case 100 is installed on electronic device 170 may provide useful information for purposes of assessing or evaluating a warranty or damage claim that protective case 100 did not properly protect electronic device 170. In other words, if a user claims that electronic device 170 incurred some damage even though protective case 100 was installed on electronic device 170 it may be useful to have captured data verifying whether or not protective case 100 was in fact installed on electronic device 170 previously and/or at the time of the alleged damage. In some situations, the determination regarding the installation or presence of the case may be made at various points in time, including quasi-random points in time that may not be known to the user.

There may also be other benefits or purposes for automatically, remotely, periodically, randomly, and/or electronically detecting if protective case 100 is or was installed on electronic device 170 at any particular time. In another example, a warranty or guarantee associated with electronic device 170 may have different terms or durations, such as a longer warranty for example, if electronic device 170 is kept in protective case 100. In another example, electronic device 170 may only be permitted to be used in certain environments if protective case 100 is installed.

In many examples, electronic device 170 includes a haptic motor, an eccentric motor, and/or another type of vibration generation device for providing a user of electronic 170 a haptic or physical notification in addition to or in place of audio notifications and/or visual notifications. Electronic device 170 may include a haptic motor, a haptic mechanism, a motor with an offset weight, a vibrating mass, a non-balanced moving mass, and/or another electromechanical device for generating a vibration or haptic event in electronic device 170.

In many examples, electronic device 170 may also include one or more accelerometers or motion sensors for detecting acceleration and/or motion of electronic device 170. The accelerometers or motions sensors may detect acceleration or motion, respectively, in one, two, three, or more axes. In one example, an accelerometer package includes a 3 axis accelerometer in a single assembly or package. One or more computers or microprocessors of electronic device 170 may read or otherwise receive data from accelerometers or motions sensors.

Using the techniques disclosed herein, an accelerometer and/or motion sensor of electronic device 170 may be used to detect when a haptic motor, haptic mechanism, or vibration generation device is activated or operated on electronic device 170. Further, the signature and/or characteristics of the detected acceleration or motion will be different depending on whether protective case 100 is installed on electronic device 170. In other words, data or signals generated by the acceleration or motion sensor(s) will be different depending on whether protective case 100 is installed and this information can be used to determine if protective case 100 is installed on electronic device 170 at any particular point in time.

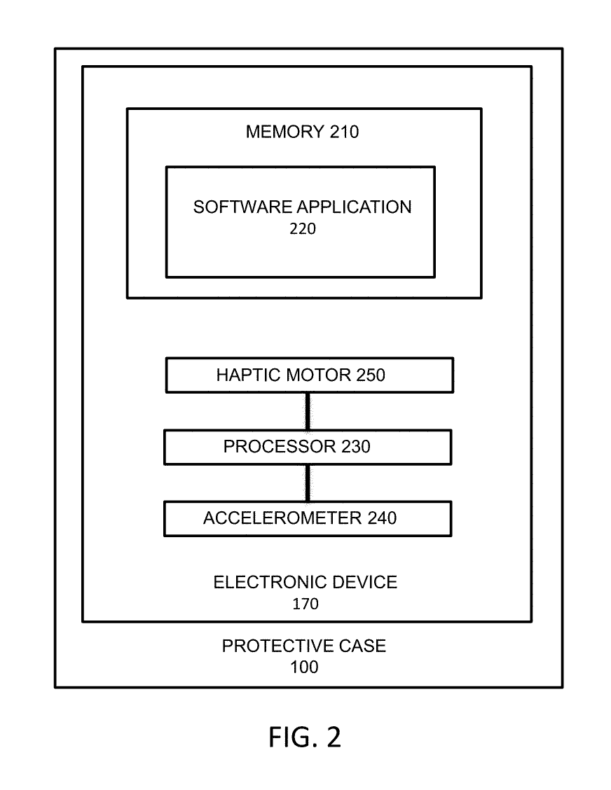

In one example illustrated in FIG. 2, a software application 220, or app, is stored in a non-volatile memory device, such as memory 210, and is executable by one or more computer processors 230 of electronic device 170. Software application 220 comprises non-transitory instructions stored on a non-transitory storage medium, such as memory 210. Software application 220 may be downloaded from a remote computer system through a wired or through a wireless connection. In one example, software application 220 may be downloaded from an application repository, application server, app server, or an app store. Software application 220 may be included in one or more other software applications and/or computer programs. In other configurations, some or all of software application 220 may reside on a remote computing system and be executed, at least in part, from that remote computing system using electronic device 170.

When executed, software application 220 causes processor 230 to activate, enable, drive, and/or trigger haptic motor 250 to generate a vibration. At the same time, accelerometer 240 captures and/or stores data pertaining to motion and/or acceleration of electronic device 170 when haptic motor 250 is generating a vibration. Processor 230 receives the data and compares the received data to past data, known characteristics, stored profiles, and/or previously determined response signatures. Because the resulting vibration of electronic device 170 differs depending on whether protective case 100 is installed on electronic device 170, the comparison of the data to past data, known characteristics, stored profiles, and/or previously determined response signatures can be used to determine whether protective case 100 is installed on electronic device 170. The determination may be made based on acceleration measurement in one, two, three, or more axes. Measurements in multiple axes may be made using a single accelerometer or motion sensor, multiple accelerometers or motions sensors, or any combination thereof.

The detected or measured differences in the acceleration data or signals when protective case 100 is installed may include greater acceleration, reduced acceleration, higher magnitude acceleration, lower magnitude acceleration, higher frequency characteristics, lower frequency characteristics, damped characteristics, amplified characteristics, shorter duration responses, longer duration responses, and/or any combination thereof. Presence of protective case 100 may change the vibration or resonance characteristics of electronic device 170 in a variety of ways. In some situations, the vibration or resonance characteristics may vary further depending on whether electronic device 170 is being held by the user, is in a pocket, is in a bag, is on a relatively hard surface, is on a relatively soft surface, is attached to a cable, is in a non-horizontal orientation, and/or combinations thereof. In some situations, it may not be clear from an individual measurement whether protective case 100 is installed are not and measurements taken at various times may be collectively statistically analyzed to make case presence determinations.

While an electronic device, such as electronic device 170, may already include some or all of the electrical and mechanical components discussed above, software application 220 enables the electronic device 170 to operate in a new and different manner to produce new and different results and enables it to use the electrical and mechanical components together for new and different purposes not previously anticipated.

In one example, the measurement processes described herein may be performed periodically. In another example, the measurement processes described herein may be performed at random or quasi-random intervals. In another example, the measurement processes described herein may be performed when manually requested by the user of electronic device 170. In another example, the measurement processes described herein may be performed in response to receiving a message or request from a remote computer or system. In another example, the measurement processes described herein may be performed in response to another event or trigger encountered by or generated by processor 230 and/or electronic device 170.

In another example, the measurement processes described herein may be performed at times or intervals specified in software application 220. In some situations, the user may not know, be aware, or have advance notice when a measurement will occur in order to check for the presence of protective case 100 at various times without the user being able to install protective case 100 just prior to or in preparation for the measurement.

In another example of operation, haptic motor 250 may not be activated specifically for purposes of making the case detection measurements described herein. Software application 220 and/or processor 230 may monitor operation of electronic device 170 and/or an operating system of electronic device 170 and make measurements using accelerometer 240 when haptic motor 250 is already being activated for another purpose, such as notification of an email, text, or phone call. Beneficially, the user is not misled to believe he or she has a message when a case detection measurement takes place and/or may not even know when the case detection measurement is taking place.

In other examples, software application 220 may include instructions that generate a user interface and/or user controls on an interface of electronic 170 to enable the user to activate the software application, configure the software application, initiate a measurement, calibrate the software application or measurements, view results of measurements, store results of measurements, transmit measurements to one or more other devices, and/or combinations thereof. In some situations, a calibration process may initially be performed to identify parameters or data used in later determinations or measurements regarding the presence of the case.

In some implementations, a vibration may be generated using a device other than, or in addition to, haptic motor 250, such as using a speaker, a solenoid, and/or an ultrasonic exciter.

In some implementations, vibration characteristics or responses may be detected using a device other than accelerometer 240, such as using a motion sensor, a microphone and/or a pressure sensor.

In some implementations, the vibration may include particular frequencies, modulation patterns, signatures, and/or other characteristics which are particularly useful in making distinctions between the presence and absence of a case.

In some situations, protective case 100 may include features or characteristics to enhance the differentiation of the response detected by the accelerometer when a protective case is installed versus when a protective case is not installed. In one example, a change may be made to the type of viscoelastic materials used to construct the protective case. These materials may include thermoplastic elastomers, thermoplastic urethanes, silicones, or other flexible materials which have a distinctive or varied response to the vibration. Other materials for other portions of the protective case may also be selected or varied to produce particular results and may include polycarbonate, nylon, polycarbonate and ABS blends, ABS, metals, and/or other materials with similar stiffnesses.

Further, the geometry of the viscoelastic materials and/or structural materials used to construct the protective case may be designed or varied in such a way to create a differentiated frequency response for the protective case. In one example, a mass may be added to the case construction in such a way to create a differentiated frequency response for the case. In another example, a structure may be formed in or on the case through use of specific materials and/or geometries such that the case has a greater tendency to resonate with the frequency of the vibration source, thereby making the case more detectable since the accelerometer would be more highly excited when the case is present.

In yet another example of varying the construction of the case to enhance or further distinguish the vibration response when the case is installed, a structure may be added to the case such that the case vibration modes are out of phase with the vibration source, thereby significantly canceling or damping the accelerometer response, which would also make the case more detectable. Such structure may be a structure which is adhered to case, embedded to the case, or formed as part of the case.

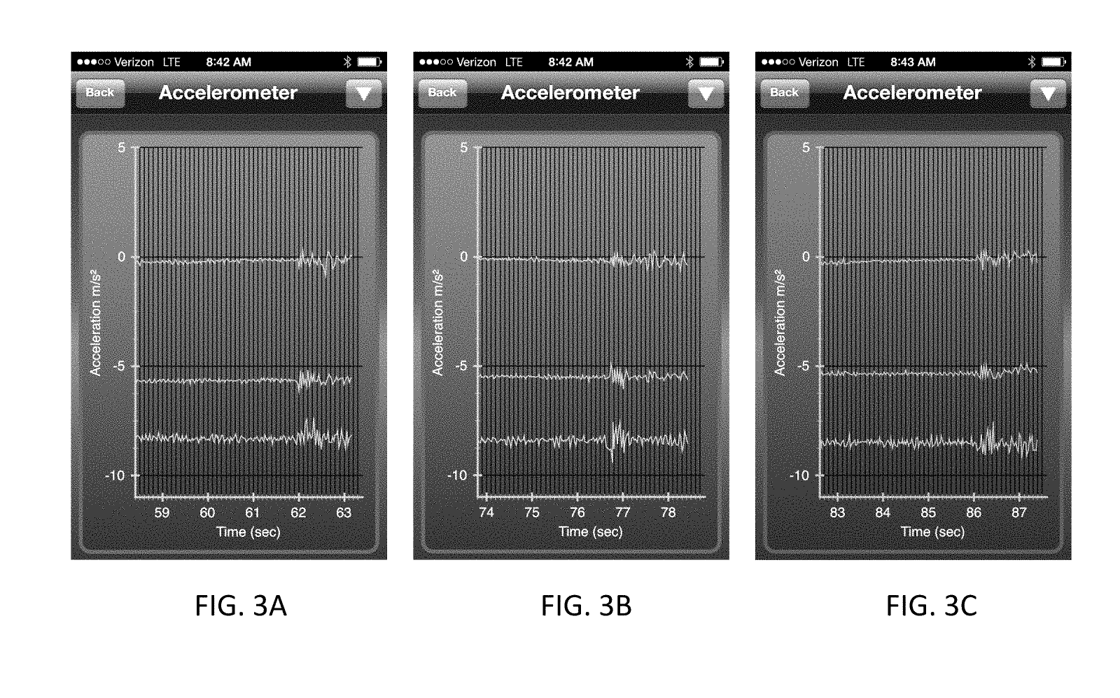

FIGS. 3A-3C illustrate vibration response measurement data taken from an electronic device with no protective case installed. Each of FIGS. 3A-3C illustrate vibration response measurement data taken in 3 different axes, for example x, y, and z axes. In the example of FIGS. 3A-3C, the electronic device is held in the user's hand. The determinations, measurements, and comparisons discussed herein may be made based on any combination of data from one, two, or three axes.

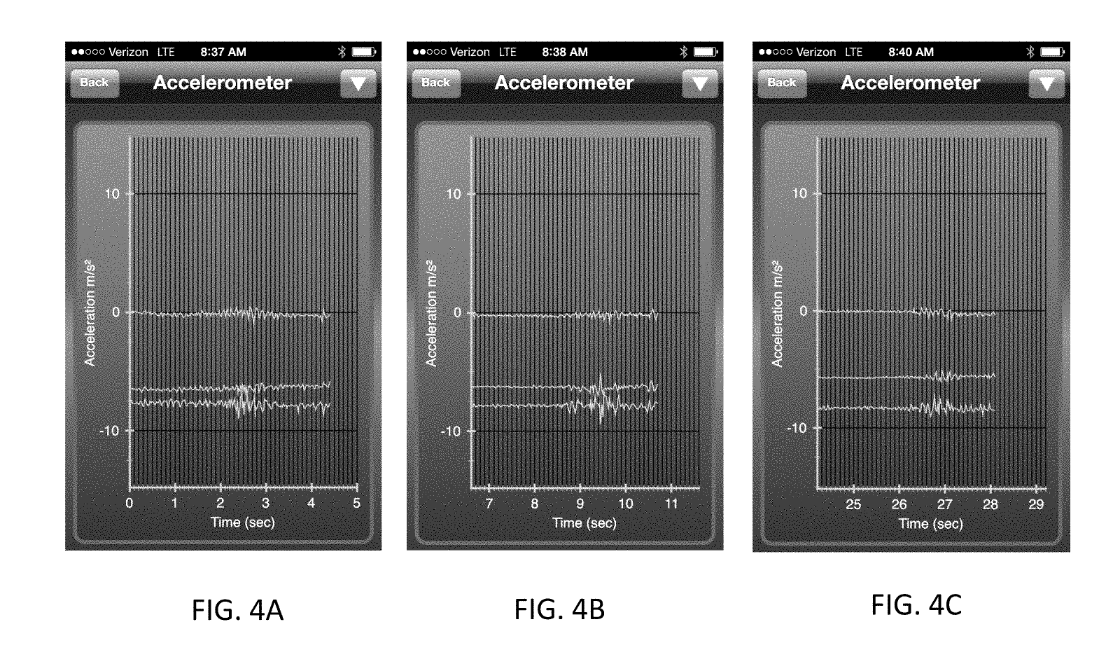

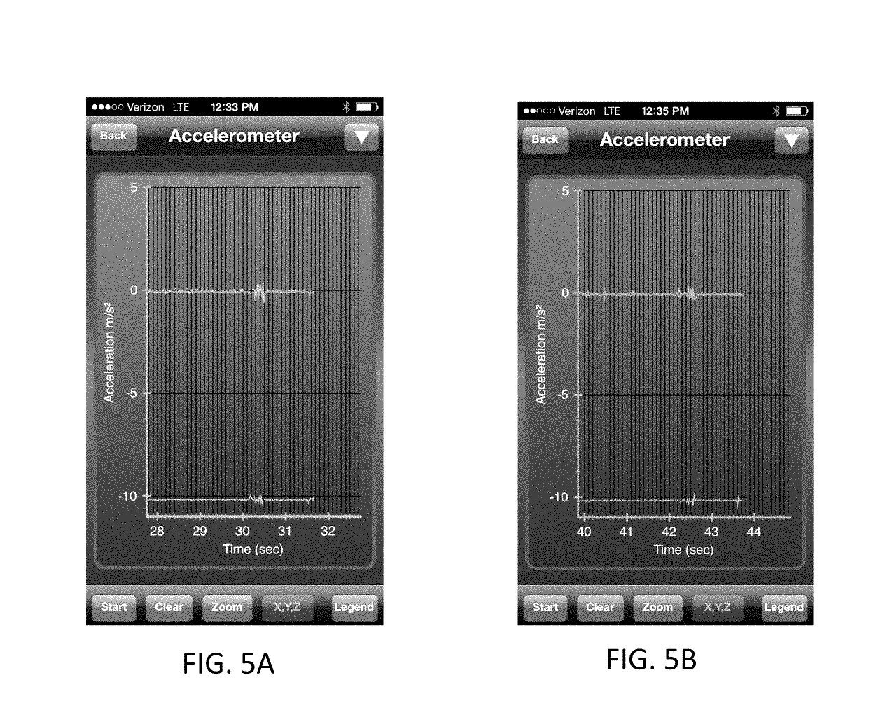

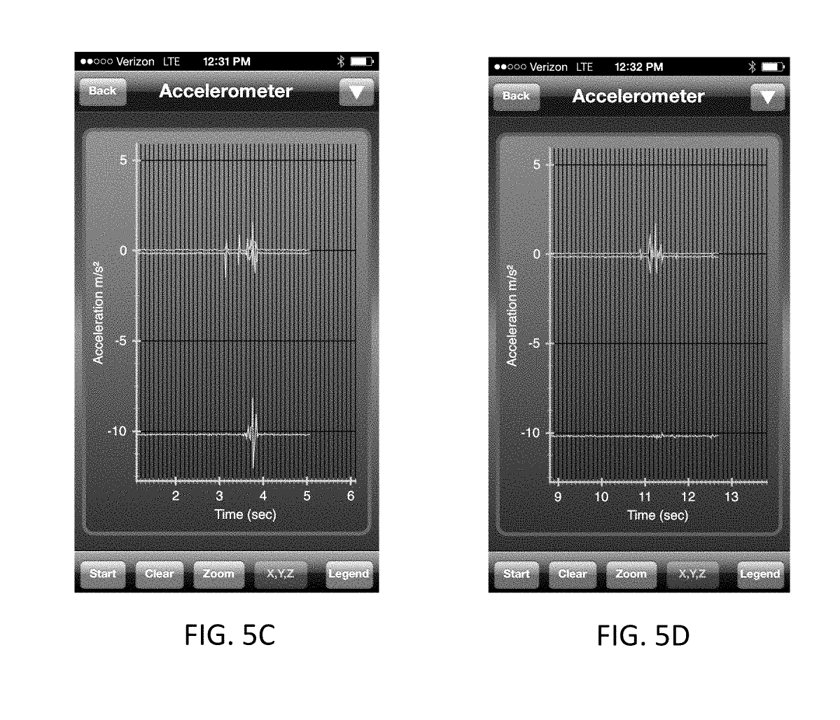

FIGS. 4A-4C illustrate vibration response measurement data taken from the electronic device with a protective case installed and illustrate the difference in the acceleration responses relative to FIG. 3A-3C. As with FIGS. 3A-3C, each of FIGS. 4A-4C illustrate vibration response measurement data taken in 3 different axes, for example x, y, and z axes. Beneficially, the differences between the data of FIGS. 3A-3C and FIGS. 4A-4C may be used to determine if a protective case is present on the electronic device. In contrast to FIGS. 3A-3C, FIG. 5A-5D illustrate vibration response measurement data taken from an electronic device with no protective case installed while the electronic device is sitting on a table.

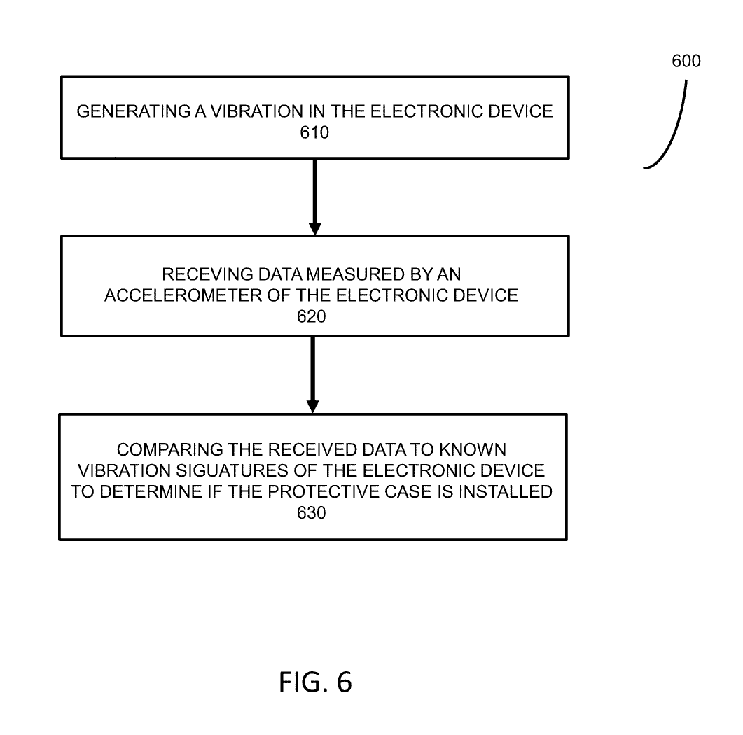

FIG. 6 illustrates a method 600 of detecting presence of a protective case on an electronic device. Step 610 of method 600 includes generating a vibration in the electronic device. Step 610 may include generating the vibration in the electronic device through activation of a haptic mechanism of the electronic device when the protective case is installed on the electronic device. Step 620 of method 600 includes receiving data measured by an accelerometer of the electronic device where the data is measured during the generation of the vibration. Step 630 of method 600 includes comparing the received data to known vibration signatures of the electronic device to determine if the protective case is installed on the electronic device. The known vibration signatures include at least one vibration signature associated with the electronic device when the protective case is not installed on the electronic device and at least one vibration signature associated with the electronic device when the protective case is installed on the electronic device. Other methods and variations of the method 600 are possible.

The elements, components, and steps described herein are meant to exemplify some types of possibilities. In no way should the aforementioned examples limit the scope of the invention, as they are only exemplary embodiments.

The phrases “in some embodiments,” “according to some embodiments,” “in the embodiments shown,” “in other embodiments,” “in some examples,” “in other examples,” “in some cases,” “in some situations,” “in one configuration,” “in other situations,” “in another configuration,” and the like generally mean that the particular technique, feature, structure, or characteristic following the phrase is included in at least one embodiment of the present invention and/or may be included in more than one embodiment of the present invention. In addition, such phrases do not necessarily refer to the same embodiments or to different embodiments.

The foregoing disclosure has been presented for purposes of illustration and description. Other modifications and variations may be possible in view of the above teachings. The embodiments described in the foregoing disclosure were chosen to explain the principles of the concept and its practical application to enable others skilled in the art to best utilize the invention. It is intended that the claims be construed to include other alternative embodiments of the invention except as limited by the prior art.

What is claimed is:

1. A system for detecting presence of a protective case on an electronic device, the system comprising:
a removable protective case for the electronic device; and
a set of computer instructions storable on a non-transitory storage medium, the set of computer instructions executable by a computer processor of the electronic device to direct the electronic device to:
generate a vibration of the electronic device through activation of a haptic motor of the electronic device;
receive data measured by an accelerometer of the electronic device, the data measured during the generation of the vibration; and
compare the received data to a known vibration signature of the electronic device to determine if the protective case is installed on the electronic device.

2. The system of claim 1 wherein the set of computer instructions further direct the electronic device to:
generate a vibration of the electronic device through activation of the haptic motor of the electronic device when the protective case is not installed on the electronic device; and
receive data measured by the accelerometer of the electronic device to generate the known vibration signature of the electronic device.

3. The system of claim 1 wherein the removable protective case is a waterproof removable protective case.

4. The system of claim 3 wherein the waterproof removable protective case includes a transparent membrane for operating an interactive touchscreen of the installed electronic device through the transparent membrane.

5. The system of claim 4 wherein the set of computer instructions further direct the electronic device to display user instructions on the interactive touchscreen of the installed electronic device.

6. The system of claim 1 wherein the electronic device is a smartphone.

7. The system of claim 1 wherein the set of computer instructions further direct the electronic device to:
generate a second vibration of the electronic device through a second activation of the haptic motor of the electronic device;
receive second data measured by the accelerometer of the electronic device, the second data measured during the generation of the second vibration; and
compare the second received data to a second known vibration signature of the electronic device to further determine if the protective case is installed on the electronic device.

8. The system of claim 7 wherein an axis of the electronic device associated with the data measured by the accelerometer is different than an axis of the electronic device associated with the second data measured by the accelerometer.

9. The system of claim 1 wherein the generating, receiving, and comparing is repeatedly performed at quasi-random intervals.

10. The system of claim 1 wherein to compare the received data to the known vibration signature of the electronic device to determine if the protective case is attached to the electronic device includes to determine that a magnitude associated with the received data is different than a magnitude associated with the known vibration signature.

11. The system of claim 1 wherein to compare the received data to the known vibration signature of the electronic device to determine if the protective case is attached to the electronic device includes to determine that a frequency associated with the received data is different than a frequency associated with the known vibration signature.

12. The system of claim 1 wherein to receive data measured by the accelerometer of the electronic device includes to receive a plurality of data measurements made at different points in time and to compare the received data to the known vibration signature of the electronic device includes to compare the plurality of data measurements to the known vibration signature.

13. The system of claim 1 wherein the set of computer instructions is downloadable from a remote computer system.

14. A method of detecting presence of a protective case on an electronic device, the method comprising:
generating a vibration in the electronic device through activation of a haptic mechanism of the electronic device when the protective case is installed on the electronic device and a least partially covers a housing of the electronic device;
receiving data measured by an accelerometer of the electronic device, the data measured during the generation of the vibration; and
comparing the received data to known vibration signatures of the electronic device to determine if the protective case is installed on the electronic device, wherein the known vibration signatures include at least one vibration signature associated with the electronic device when the protective case is not installed on the electronic device and at least one vibration signature associated with the electronic device when the protective case is installed on the electronic device.

15. The method of claim 14 further comprising generating the at least one vibration signature associated with the electronic device when the protective case is not installed on the electronic device.

16. The method of claim 14 further comprising generating the at least one vibration signature associated with the electronic device when the protective case is installed on the electronic device.

17. The method of claim 14 further comprising transmitting results of the comparing to a remote computer system.

18. The method of claim 14 wherein receiving the data measured by the accelerometer includes receiving two or more data sets, each data set associated with a different axis of the electronic device.

19. The method of claim 14 wherein the steps of generating, receiving, and comparing are repeated at a plurality of different points in time.

20. The method of claim 14 wherein the comparing includes comparing one or more of magnitudes and frequencies.
